(19) United States
(12) Patent Application Publication
(10) Pub. No.: US 2023/0114931 A1
(43) Pub. Date: Apr. 13, 2023

(54) INFORMATION PROCESSING APPARATUS, INFORMATION PROCESSING METHOD, AND RECORDING MEDIUM

(71) Applicant: TOYOTA JIDOSHA KABUSHIKI KAISHA, Toyota-shi (JP)

(72) Inventors: Osamu NAGASAKA, Toyota-shi (JP); Norihiko OSHIO, Nagoya-shi (JP); Kosuke SAKAKIBARA, Toyota-shi (JP); Naoya OKA, Nagakute-shi (JP)

(73) Assignee: TOYOTA JIDOSHA KABUSHIKI KAISHA, Toyota-shi (JP)

(21) Appl. No.: 17/823,225

(22) Filed: Aug. 30, 2022

(30) Foreign Application Priority Data
Oct. 11, 2021 (JP) 2021-166959

(51) Int. Cl. G07C 5/08; G06K 7/14

(52) U.S. Cl. CPC G07C 5/0841; G06K 7/1443

(57) ABSTRACT

An information processing apparatus acquiring history information about a vehicle. The information processing apparatus includes a processor that performs reading a code printed on a sticker attached to a vehicle body, and transmits, to a first apparatus, first data requesting the history information, based on a result of the reading.

### CROSS REFERENCE TO THE RELATED APPLICATION

This application claims the benefit of Japanese Patent Application No. 2021-166959, filed on Oct. 11, 2021, which is hereby incorporated by reference herein in its entirety.

### BACKGROUND

### Technical Field

The present disclosure relates to upgrading of a vehicle.

### Description of the Related Art

Evaluation of a used vehicle is known to change depending on options, mounted equipment and the like. In this regard, Japanese Patent Laid-Open No. 2005-346170 discloses a system that registers a history (a part replacement history, a maintenance history and the like) of a vehicle that is sold as a used vehicle, in a server apparatus, and that provides the history to consumers.

An object of the present disclosure is to acquire a maintenance history of a vehicle by a simple method.

### SUMMARY

A first aspect of the present disclosure is an information processing apparatus acquiring history information about a vehicle, the information processing apparatus including a processor that performs reading a code printed on a sticker attached to a vehicle body, and transmits, to a first apparatus, first data requesting the history information, based on a result of the reading.

Furthermore, a second aspect of the present disclosure is an information processing method performed by an information processing apparatus acquiring history information about a vehicle, the information processing method including performing reading a code printed on a sticker attached to a vehicle body, and transmitting, to a first apparatus, first data requesting the history information, based on a result of the reading.

Furthermore, another aspect of the present disclosure is a program for causing a computer to perform the information processing method described above, or a computer-readable storage medium non-transitorily storing the program.

According to the present disclosure, a maintenance history of a vehicle may be acquired by a simple method.

### BRIEF DESCRIPTION OF THE DRAWINGS

FIG. 1 is a diagram for describing an outline of a vehicle system;

FIG. 2 is a view illustrating an example of a sticker to be attached to a vehicle body;

FIG. 3 is a view for describing a location where the sticker is attached;

FIG. 4 is a diagram illustrating components of a user terminal 100;

FIG. 5 is a diagram illustrating components of a vehicle management server 200;

FIG. 6 is an example of maintenance history data that is stored in a storage unit;

FIG. 7 is a diagram illustrating components of a site server 300;

FIG. 8 is a sequence diagram illustrating processes that are performed by each component of the system;

FIG. 9 is an example of a screen for notification of an attachment location of the sticker;

FIG. 10 is an example of a user interface screen including a search form;

FIG. 11 is a flowchart describing in detail processes that are performed in step S25;

FIG. 12 is an example of a user interface screen including a list of a plurality of maintenance histories;

FIG. 13 is an example of a caution plate;

FIG. 14 is a sequence diagram illustrating processes that are performed by the user terminal 100 and the vehicle management server 200 according to a second embodiment;

FIG. 15 is an example of a screen for notification of attachment locations of the sticker and the caution plate;

FIG. 16 is a flowchart of processes that are performed by a control unit 101 in step S21A; and

FIG. 17 is an example of a screen outputting a recognition state of the sticker and the caution plate.

### DESCRIPTION OF THE EMBODIMENTS

There are techniques for replacing or updating parts (vehicle parts) of a vehicle in an ex-post manner. For example, fabric seats may be replaced with leather ones, or a steering wheel may be replaced with one with a built-in heater. Furthermore, by updating software of an in-vehicle computer, functions (functions related to safety, traveling support functions and the like) not installed at a time of sale of a new vehicle may be added.

In the present disclosure, enhancing the function or quality of a vehicle part through replacement of a part or update of software will be referred to as “upgrade”.

The value of a used vehicle may be increased by upgrading vehicle parts. Accordingly, a vehicle manufacturer desirably certifies that upgrade is performed by an authorized program. For example, when a sticker displaying that a predetermined vehicle part is upgraded is attached to a vehicle body, whether upgrade is performed or not may be grasped at a glance.

However, a vehicle includes various vehicle parts, and simply attaching a sticker does not facilitate determination of which vehicle part of the vehicle is replaced with a part of what grade.

An information processing apparatus according to the present disclosure solves such a problem.

An information processing apparatus according to a first aspect of the present disclosure is an information processing apparatus acquiring history information about a vehicle, the information processing apparatus including a processor that performs reading a code printed on a sticker attached to a vehicle body, and transmits, to a first apparatus, first data requesting the history information, based on a result of the reading.

The sticker according to the present disclosure is a label displaying that at least one of a plurality of vehicle parts of a vehicle is upgraded. For example, the sticker is attached at a certain position of a vehicle body (typically, a center pillar). For example, one sticker is attached to one vehicle. That is, a vehicle to which the sticker is attached is a vehicle that is upgraded in some way.

Note that the sticker may be a laminated piece of paper, a metal plate or the like.

The first apparatus is an apparatus that provides the history information about a vehicle. The history information is information about a history of maintenance work and the like performed on a vehicle, and includes an upgrade history of vehicle parts, a maintenance history of the vehicle, a repair history and the like.

For example, the first apparatus may be a server apparatus that includes a database storing the history information of a plurality of vehicles, and that provides a service of searching for the history information in response to a request from another apparatus.

A code for accessing the first apparatus is printed on the sticker according to an embodiment. The code printed on the sticker may be obtained by encoding a network address (such as a URL) of the first apparatus or a service provided by the first apparatus, for example. The code may be a two-dimensional code or the like, for example.

The processor transmits, to the first apparatus, data for requesting the history information, based on a result of reading such a sticker. The processor may optically read the sticker by means of a camera or the like. For example, in the case where a two-dimensional code is printed on the sticker, the network address corresponding to the first apparatus may be acquired by reading and decoding the two-dimensional code. According to such a mode, access to the first apparatus may be provided by a simple configuration.

Furthermore, the processor may read information for identifying a target vehicle (such as an identifier of a vehicle), together with the code. The identifier of a vehicle may be a chassis number, for example. In the case where a plate (a caution plate) on which the identifier (the chassis number) of the vehicle is written is attached near the sticker, the sticker and the plate may be read at the same time. This allows connection to the first apparatus and transmission of the identifier to be performed seamlessly.

Hereinafter, specific embodiments of the present disclosure will be described with reference to the drawings. Hardware configurations, module configurations, functional configurations and the like described in each embodiment are not intended to limit the technical scope of the present disclosure thereto unless stated otherwise.

### First Embodiment

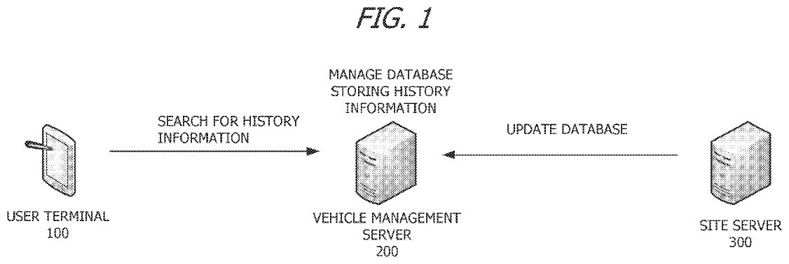

An outline of a vehicle system according to a first embodiment will be described with reference to FIG. 1.

The vehicle system according to the present embodiment includes a user terminal 100, a vehicle management server 200 that stores information about a vehicle, and a site server 300 corresponding to a site where maintenance work is performed on a vehicle (hereinafter “vehicle site”).

The user terminal 100 is an information processing apparatus that is used by a user who is associated with a vehicle. A user who is associated with a vehicle may be an owner of the vehicle, a person who performs maintenance on the vehicle, a person who is to make an assessment of the vehicle, and the like. The user terminal 100 may be a terminal that is owned by an end user (for example, the owner of the vehicle), or may be a terminal installed at a sales office of a vehicle manufacturer, a sales office of a vehicle dealer, or a maintenance site for vehicles.

The vehicle management server 200 is a server apparatus that manages a database storing a history of maintenance work and the like performed on a vehicle (hereinafter “history information”). For example, the history information includes information about repair, information about upgrade of a vehicle part, information about replacement of consumables, and the like.

The vehicle management server 200 is capable of searching the database based on a request received from the user terminal 100, and of providing the history information about a predetermined vehicle to the user.

The site server 300 is a server apparatus that is associated with the vehicle site where maintenance work is performed on a vehicle. For example, the vehicle site is a vehicle manufacturing factory, a maintenance workshop, a car dealer or the like. When maintenance work is performed on a vehicle, the site server 300 generates data indicating the details of the maintenance work (hereinafter “work data”), and transmits the data to the vehicle management server 200. The database is thus updated.

A user who wants to acquire an upgrade history of a given vehicle requests the history information from the vehicle management server 200, via the user terminal 100. The user terminal 100 accesses the vehicle management server 200 using a sticker attached to the target vehicle.

The sticker in the present disclosure will be described. The sticker in the present disclosure is a label that is attached to a vehicle to certify that at least one of a plurality of vehicle parts of the vehicle is upgraded.

Examples of the plurality of vehicle parts of a vehicle include an electronic control unit (ECU), an in-vehicle computer, a communication device, an infotainment terminal, an air conditioner, a seat, a steering wheel, a door, a sunroof, a mirror, and other electric components. In the description of the embodiment, the target of upgrade is a vehicle part, but the target of upgrade may instead be a component formed from a plurality of vehicle parts. In this case, a component may be upgraded by replacing the plurality of vehicle parts forming the component.

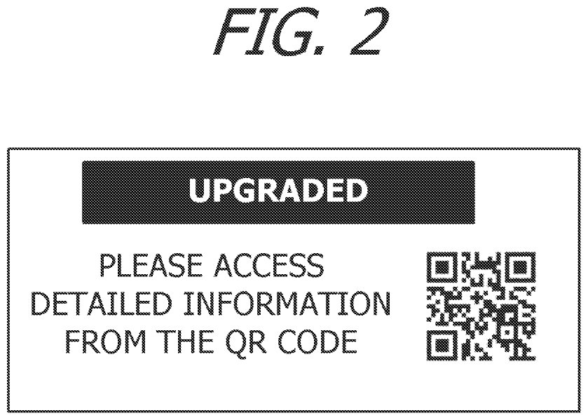

FIG. 2 is a view illustrating an example of the sticker. For example, text indicating that upgrade of a certain vehicle part is performed, or that a certain vehicle part is replaced with an upgraded part is written on the sticker. The text to be written on the sticker is not particularly limited as long as it can be determined that the vehicle is updated in some way.

The sticker includes a two-dimensional code for searching for the history information of the vehicle. The two-dimensional code is obtained by encoding a network address of a service, provided by the vehicle management server 200, for searching for the history information of a vehicle (hereinafter “history search service”). The user terminal 100 may connect to the history search service provided by the vehicle management server 200, by reading the two-dimensional code.

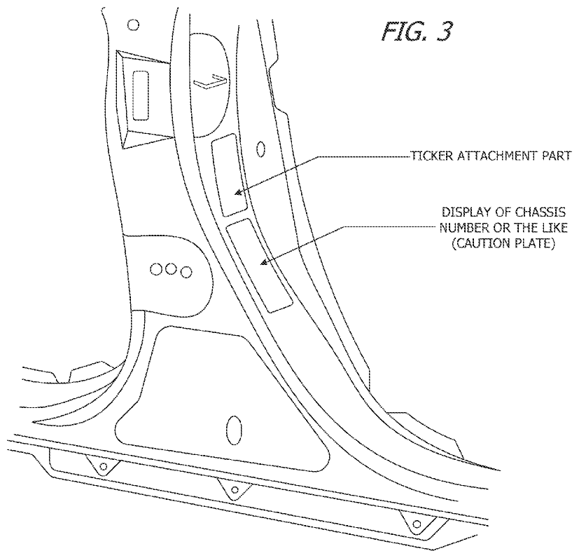

The sticker is attached to a predetermined part of the vehicle. FIG. 3 is a view for describing a location where the sticker is to be attached. FIG. 3 is a view illustrating a vehicle body frame of the vehicle as seen from a front right side. A lower side in the drawing is a side sill, and a center is a center pillar (also referred to as a B pillar).

In the present example, the sticker is attached in a predetermined region on the center pillar. The attachment part may be near a caution plate on which a chassis number or the like is written. By disposing the sticker at such a part, presence/absence of an upgrade may be easily checked by opening a door.

Next, the user terminal 100 will be described in detail.

The user terminal 100 is a computer that is used by a user who is associated with a vehicle. The user may access the vehicle management server 200 via the user terminal 100, and may search the history information of a given vehicle. The user terminal 100 is a personal computer, a smartphone, a mobile phone, a tablet terminal, a personal digital assistant or the like, for example.

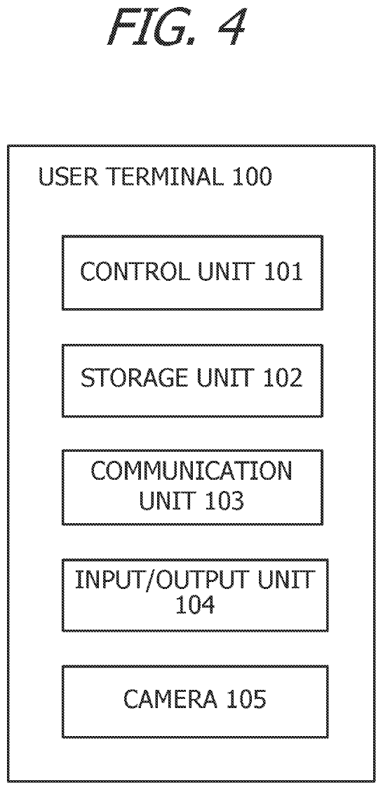

FIG. 4 is a diagram illustrating a system configuration of the user terminal 100.

The user terminal 100 includes a control unit 101, a storage unit 102, a communication unit 103, an input/output unit 104, and a camera 105.

The control unit 101 is an arithmetic device in charge of control that is performed by the user terminal 100. The control unit 101 may be implemented by an arithmetic processing device such as a central processing unit (CPU).

The control unit 101 implements a function of accessing the vehicle management server 200, and interacting with the vehicle management server 200. This function may be implemented by a web browser running on the user terminal 100, or by dedicated application software.

In the present embodiment, the control unit 101 is capable of communicating with the vehicle management server 200, and of executing application software for searching for the history information.

The storage unit 102 includes a main memory and an auxiliary memory. The main memory is a memory where programs to be executed by the control unit 101, and data to be used by the control programs are developed. The auxiliary memory is a device where the programs to be executed by the control unit 101, and the data to be used by the control programs are stored. Programs to be executed by the control unit 101 may be packaged as applications and be stored in the auxiliary memory. Furthermore, an operating system for executing the applications may also be stored. Processes described later are performed by the programs stored in the auxiliary memory being loaded into the main memory and executed by the control unit 101.

The main memory may include a random-access memory (RAM) and a read-only memory (ROM). Furthermore, the auxiliary memory may include an erasable programmable ROM (EPROM) and a hard disk drive (HDD). Furthermore, the auxiliary memory may include a removable medium, or in other words, a removable recording medium.

The communication unit 103 is a wireless communication interface for connecting the user terminal 100 to a network. The communication unit 103 is capable of communicating with the vehicle management server 200 via a wireless LAN or a mobile communication service such as 3G, LTE or 5G, for example.

The input/output unit 104 is a unit that receives an input operation performed by a user, and that presents information to the user, and is, in the present embodiment, one touch panel display, or in other words, a liquid crystal display and control means thereof, or a touch panel and control means thereof.

The camera 105 is an optical unit including an image sensor for acquiring images.

Next, the vehicle management server 200 will be described in detail.

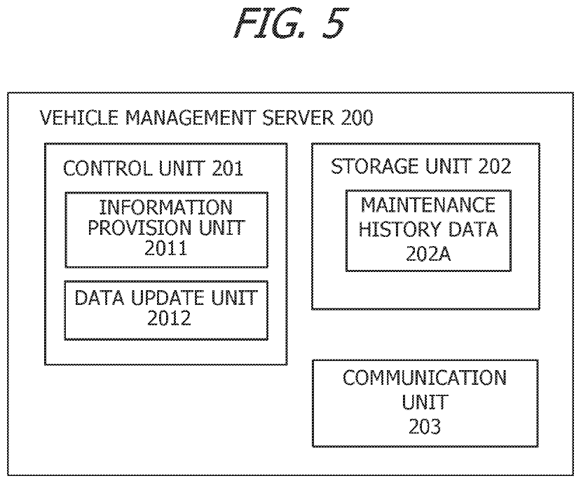

FIG. 5 is a diagram illustrating in detail components of the vehicle management server 200 included in the vehicle system according to the present embodiment.

The vehicle management server 200 is a server apparatus that stores the history information of a plurality of vehicles, and that provides the history information to the user terminal 100. The vehicle management server 200 includes a database storing, in relation to a given vehicle, the history information, or in other words, a history of repairs, a history of upgrading of vehicle parts, a history of replacement of consumables, and the like, and may update and provide the data as needed. More specifically, the vehicle management server 200 updates the database based on a request transmitted from the vehicle site (the site server 300). Furthermore, the vehicle management server 200 searches for the history information stored in the database and provides the same to the user terminal 100 in response to a request from the user terminal 100.

The vehicle management server 200 may be a general-purpose computer. That is, the vehicle management server 200 may be a computer that includes processors such as a CPU and a GPU, main memories such as a RAM and a ROM, and auxiliary memories such as an EPROM, a hard disk drive and a removable medium. The auxiliary memory stores an operating system (OS), various programs, various tables and the like, and a function matching a predetermined object as described later may be implemented by a program stored in the auxiliary memory being loaded in a work area of the main memory and being executed and each elements or the like being controlled through execution of the program. However, one or some or all of the functions may alternatively be implemented by a hardware circuit such as an ASIC or an FPGA.

In the present embodiment, the vehicle management server 200 may be capable of implementing a software server for performing interaction with the user terminal 100 and the site server 300. In this case, the user terminal 100 and the site server 300 may input/output information by accessing a service using dedicated application software, for example.

The vehicle management server 200 includes a control unit 201, a storage unit 202, and a communication unit 203.

The control unit 201 is an arithmetic device in charge of control that is performed by the vehicle management server 200. The control unit 201 may be implemented by an arithmetic processing device such as a CPU.

The control unit 201 includes two functional modules, namely, an information provision unit 2011 and a data update unit 2012. Each functional module may be implemented by execution of a stored program by the CPU.

The information provision unit 2011 provides the history information to the user terminal 100 by performing interaction with the user terminal 100. The information provision unit 2011 may generate a user interface screen for performing interaction with the user terminal 100.

In the present embodiment, the information provision unit 2011 performs a search through the database described later based on an identifier of a vehicle received from the user terminal 100, and provides the history information that is obtained to the user terminal 100. Details of the process will be given later.

The data update unit 2012 updates the database based on data transmitted from the site server 300. When maintenance work is performed on a vehicle, the site server 300 generates data indicating details of the maintenance work (the work data), and transmits the data to the vehicle management server 200. The data update unit 2012 updates the databased based on the work data that is received.

The storage unit 202 includes a main memory and an auxiliary memory. The main memory is a memory where programs to be executed by the control unit 201, and data to be used by the control programs are developed. The auxiliary memory is a device where the programs to be executed by the control unit 201, and the data to be used by the control programs are stored.

The storage unit 202 further stores maintenance history data 202A.

The maintenance history data 202A is a database storing a history (a maintenance history) of maintenance work performed on each of a plurality of vehicles being managed. The maintenance history data 202A stores the following three types of data.

### (1) History of Repairs

A history of repairing or replacing a vehicle part or a vehicle component of a vehicle.

### (2) History of Replacement of Consumables

A history of replacing or replenishing consumables of a vehicle.

### (3) Upgrade History of Vehicle Part

A history of upgrading a vehicle part or a vehicle component of a vehicle (through replacement or software update, for example). In the following, this history will be simply referred to as an upgrade history.

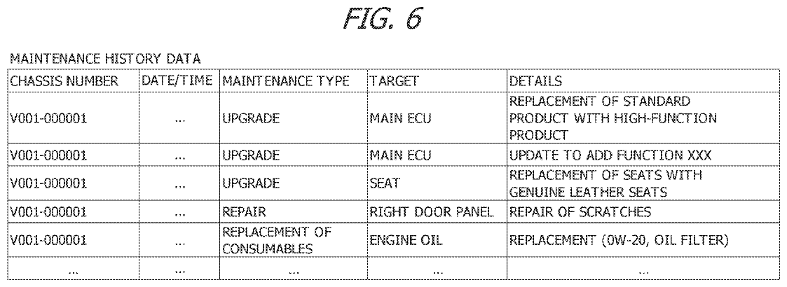

FIG. 6 illustrates an example of the maintenance history data 202A. In the present example, the maintenance history data 202A is a table including the following fields: chassis number, date/time, maintenance type, target, and details.

Data indicating the chassis number of a target vehicle is stored in the chassis number field. Data indicating date/time of performance of work is stored in the date/time field. Data indicating type (category) of maintenance work is stored in the maintenance type field. In the present example, there are three categories of “repair”, “replacement of consumables”, and “upgrade”.

Data specifying a vehicle part or a vehicle component that is a work target is stored in the target field. For example, in the case where a predetermined electronic control unit (ECU) is replaced or software thereof is updated, data specifying the ECU is stored in the target field. Furthermore, in the case where repair is performed, data specifying a vehicle part or a vehicle component (for example, a door panel) that is a repair target is stored in the target field. Moreover, in the case where replenishment/replacement of consumables is performed, data specifying the category of replenished/replaced consumables (for example, engine oil) is stored in the target field.

Data about details of maintenance work is stored in the details field. For example, in the case where contents of maintenance work are “upgrade”, data indicating the grade of a part that replaced the target vehicle part, the function that is newly added to the target vehicle part, or the like is stored in the details field. In the case where contents of maintenance work are “repair”, data indicating the type of repair work performed on the target vehicle part (or vehicle component) is stored in the details field. In the case where contents of maintenance work are “replacement of consumables”, data indicating the grade of consumables after replenishment/replacement, or the like is stored in the details field.

Each data piece described above may be constructed by managing data stored in a memory, by a program of a database management system (DBMS) executed by the processor. In this case, each data piece may be a relational database, for example.

The communication unit 203 is a communication interface for connecting the vehicle management server 200 to a network. For example, the communication unit 203 includes a network interface board, or a wireless communication interface for wireless communication.

Next, the site server 300 will be described in detail.

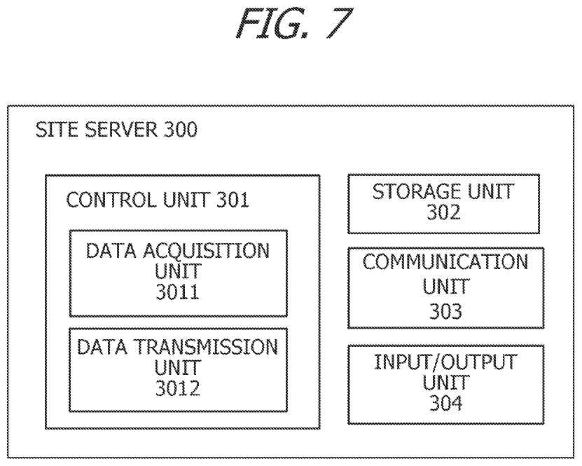

FIG. 7 is a diagram illustrating in detail components of the site server 300 included in the vehicle system according to the present embodiment.

The site server 300 is an apparatus that is installed at a site where maintenance work is performed on a vehicle, and when maintenance work is performed on a vehicle, the site server 300 transmits data about contents of the maintenance work (the work data) to the vehicle management server 200.

Like the vehicle management server 200, the site server 300 may be a general-purpose computer. That is, the site server 300 may be a computer that includes processors such as a CPU and a GPU, main memories such as a RAM and a ROM, and auxiliary memories such as an EPROM, a hard disk drive and a removable medium.

The site server 300 includes a control unit 301, a storage unit 302, a communication unit 303, and an input/output unit 304.

The control unit 301 is an arithmetic device in charge of control that is performed by the site server 300. The control unit 301 may be implemented by an arithmetic processing device such as a CPU.

The control unit 301 includes two functional modules, namely, a data acquisition unit 3011 and a data transmission unit 3012. Each functional module may be implemented by execution of a stored program by the CPU.

The data acquisition unit 3011 generates the work data based on contents of input acquired from staff at the vehicle site. The work data includes data pieces corresponding to the plurality of fields of the maintenance history data 202A. That is, the work data includes fields of chassis number, date/time, maintenance type, target, and details. The data acquisition unit 3011 acquires these data pieces via a predetermined user interface, and generates the work data.

The data transmission unit 3012 transmits the work data generated by the data acquisition unit 3011, to the vehicle management server 200.

The storage unit 302 includes a main memory and an auxiliary memory. The main memory is a memory where programs to be executed by the control unit 301, and data to be used by the control programs are developed. The auxiliary memory is a device where the programs to be executed by the control unit 301, and the data to be used by the control programs (including the work data) are stored.

The communication unit 303 is a communication interface for connecting the site server 300 to a network. For example, the communication unit 303 includes a network interface board, or a wireless communication interface for wireless communication.

The input/output unit 304 is a unit that receives an input operation performed by a user, and that presents information to the user. The input/output unit 304 may include an interface to an external display, a keyboard, a mouse and the like, for example.

The configurations illustrated in FIGS. 4, 5, and 7 are merely examples, and one or some or all of the illustrated functions may alternatively be implemented using a dedicated circuit. Furthermore, programs may be stored and executed by using a combination of a main memory and an auxiliary memory other than those illustrated.

Next, details of processes performed by the apparatuses included in the vehicle system according to the present embodiment will be given.

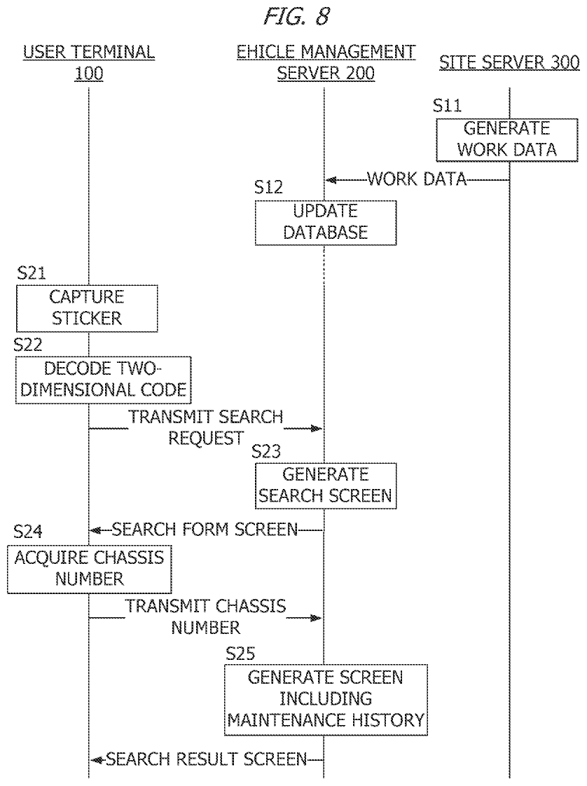

FIG. 8 is a sequence diagram illustrating processes that are performed by the user terminal 100, the vehicle management server 200, and the site server 300.

Steps S11 and S12 correspond to a phase when the site server 300 generates the work data and transmits the same to the vehicle management server 200, and the vehicle management server 200 updates the database based on the work data.

In step S11, the site server 300 generates the work data indicating contents of work performed on a predetermined vehicle. More specifically, the data acquisition unit 3011 acquires, via a predetermined user interface, the chassis number of the target vehicle, date/time information, maintenance type and target, details of work, and the like, and generates the work data. Furthermore, the data transmission unit 3012 transmits the work data to the vehicle management server 200.

In step S12, the vehicle management server 200 (the data update unit 2012) adds a record in the maintenance history data 202A based on the work data that is received.

Step S21 and subsequent steps correspond to a phase when the vehicle management server 200 provides the maintenance history based on a request from the user terminal 100.

Processes from step S21 are started at a timing when the user terminal 100 (the control unit 101) executes application software for accessing the vehicle management server 200, for example.

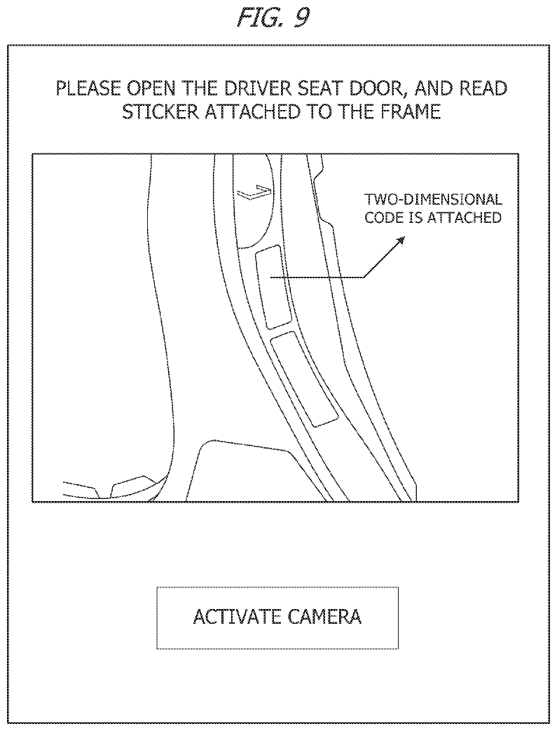

First, in step S21, the control unit 101 activates the camera 105, and makes the user capture the sticker that is attached to the target vehicle. At this time, a notice as illustrated in FIG. 9 may be output on a screen to inform the user of the attachment location of the sticker.

In step S22, the control unit 101 detects the two-dimensional code in the image acquired via the camera 105, and decodes the contents. The network address (URL) of the history search service provided by the vehicle management server 200 is thus obtained.

The user terminal 100 transmits data (first data) requesting search for history, to the history search service provided by the vehicle management server 200. The first data may be a request through HTTP, or a message in a predetermined format, for example.

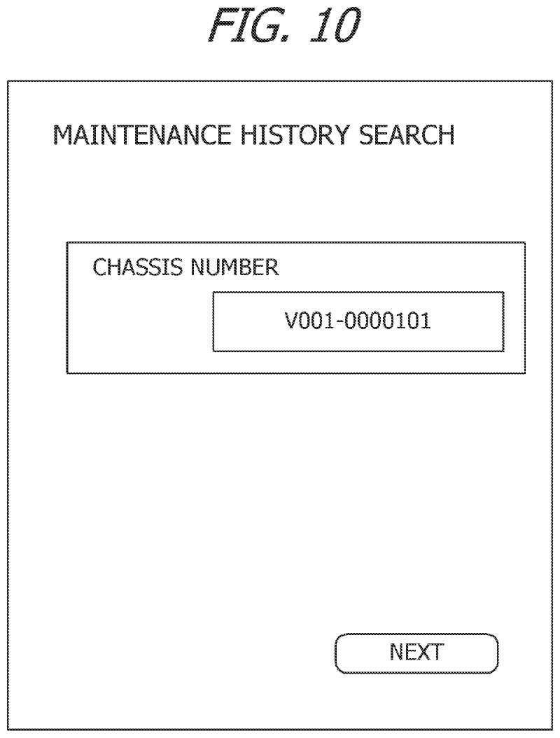

The information provision unit 2011 that received the request generates a user interface screen including a search form, and provides the same to the user terminal 100 (step S23). FIG. 10 is an example of the user interface screen including the search form. In the present example, a screen for specifying the chassis number is generated. The user terminal 100 makes the user input the chassis number using the screen (step S24). The chassis number that is acquired is transmitted to the vehicle management server 200 as second data.

In the present step, the user may also be made to input search conditions other than the chassis number. For example, the maintenance type (such as “repair”, “upgrade”, or “replacement of consumables”) to be displayed may be specified. The search conditions are transmitted to the vehicle management server 200 together with the chassis number.

In step S25, the vehicle management server 200 (the information provision unit 2011) acquires a list of maintenance history, and generates a user interface screen including the list.

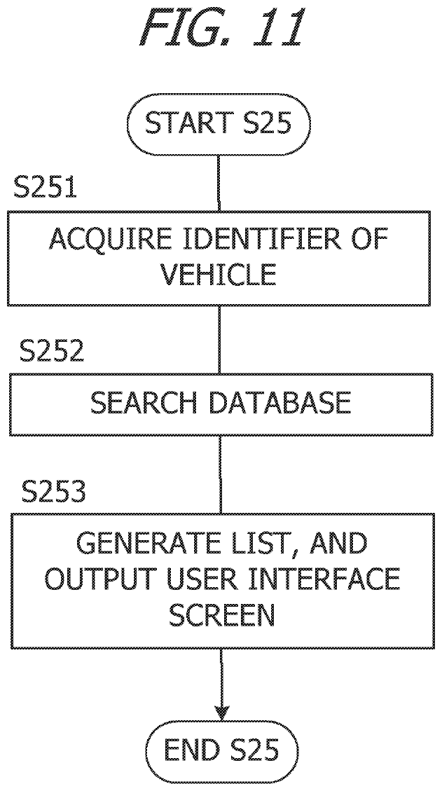

Processes that are performed in step S25 will be described in detail. FIG. 11 is a flowchart describing in detail processes that are performed in step S25.

First, in step S251, the identifier of the vehicle (that is, the chassis number) is acquired. Next, in step S252, the maintenance history data 202A is searched with the chassis number as a key, and a plurality of records corresponding to maintenance histories are acquired.

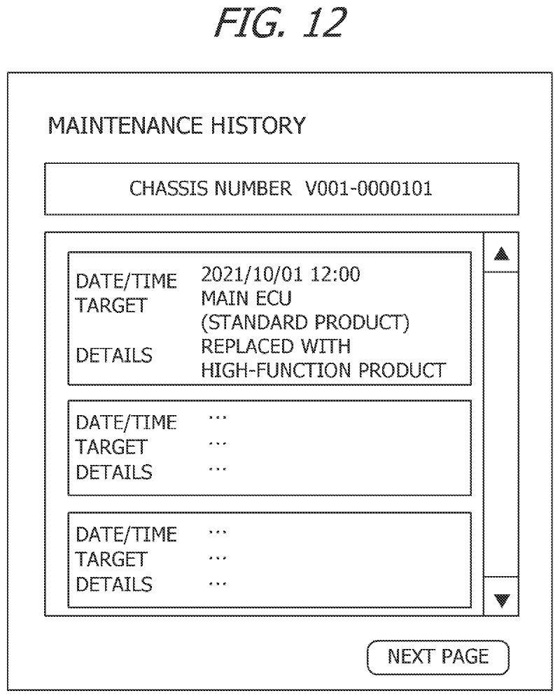

Next, in step S253, a list including the maintenance histories is generated based on the records that are acquired, and a user interface screen including the list is generated. FIG. 12 is an example of the user interface screen including the list of the plurality of maintenance histories. As illustrated, the list includes data/time when maintenance was performed, target, detailed information and the like. In the case where the maintenance type is specified, a history corresponding to the specified type (for example, upgrade) may be output.

Referring back to FIG. 8, description will be further given.

The user interface screen including the list of maintenance histories is provided to the user terminal 100, and is output by the user terminal 100. The user may thereby grasp in detail the contents of upgrade performed on a certain vehicle.

As described above, in the first embodiment, in the case where a certain vehicle part is upgraded, a sticker informing of the same is attached to the vehicle body. The sticker includes information for accessing an apparatus that provides information about maintenance of the vehicle, and access to the apparatus is enabled by the user terminal 100 reading the information.

The user may thus grasp, by a simple operation, which vehicle part of the target vehicle is replaced (or upgraded).

### Second Embodiment

In the first embodiment, the user inputs the chassis number of the target vehicle in step S24.

In this regard, a plate (a caution plate) on which detailed information about the vehicle, such as a vehicle type or the chassis number, is written is often attached to the vehicle body. In the case where the sticker is attached near the caution plate, the user terminal 100 may acquire an image including the caution plate, and may read the chassis number. The burden of inputting the chassis number may thereby be eliminated. Reading of the chassis number may be performed by a known image recognition process.

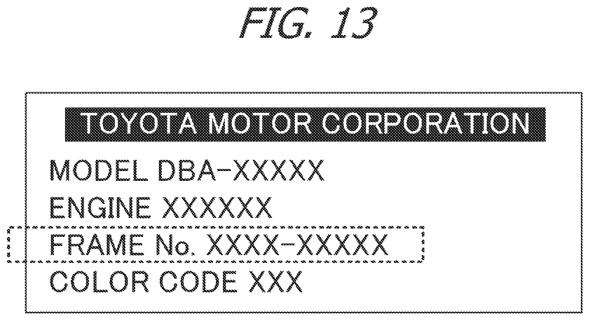

In the second embodiment, the user terminal 100 further performs a process of acquiring, via the camera 105, an image including both the sticker and the caution plate, and of recognizing the chassis number written on the caution plate. FIG. 13 is an example of the caution plate. A part indicated by a dotted line is the chassis number. Such a plate is often attached to a center pillar or the like of the vehicle, and thus, may be captured at the same time (or successively) as the sticker according to the first embodiment.

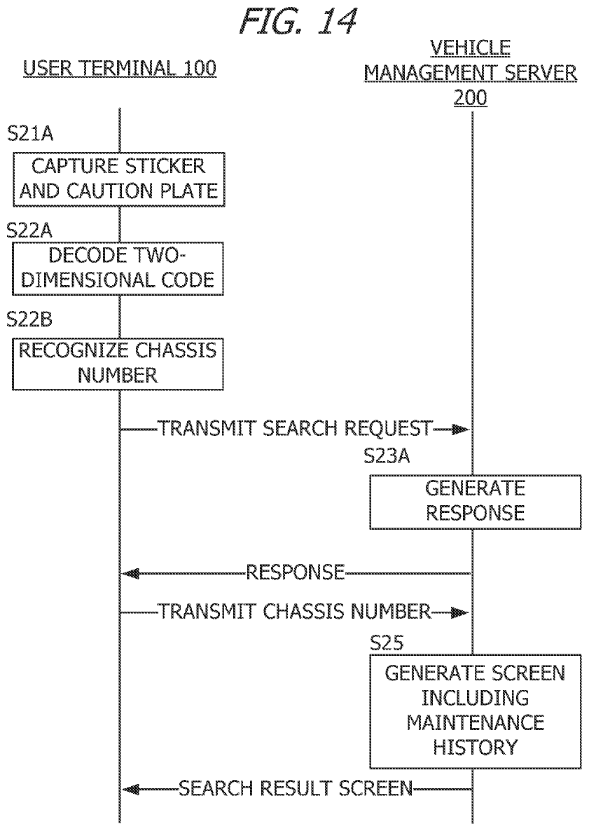

FIG. 14 is a sequence diagram illustrating processes that are performed by the user terminal 100 and the vehicle management server 200 according to the second embodiment. The illustrated processes are started at a timing when the user terminal 100 (the control unit 101) executes application software for accessing the vehicle management server 200, for example.

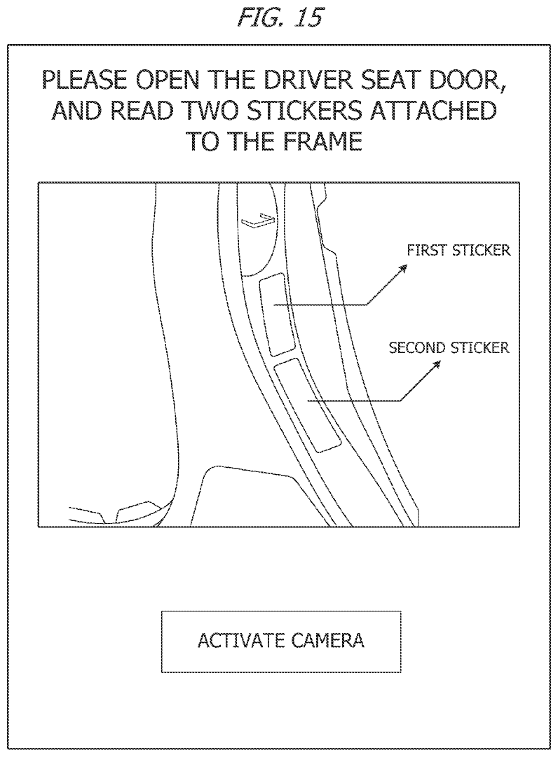

In the second embodiment, in step S21A, the control unit 101 activates the camera 105, and makes the user capture the sticker and the caution plate that are attached to the target vehicle. In the present step, one image including both the sticker and the caution plate may be acquired, or a plurality of images including the sticker and the caution plate, respectively, may be acquired. Note that the user terminal 100 may output information for notifying the user of the locations where the sticker and the caution plate are attached. For example, a screen as illustrated in FIG. 15 may be output to inform the user of the capturing target.

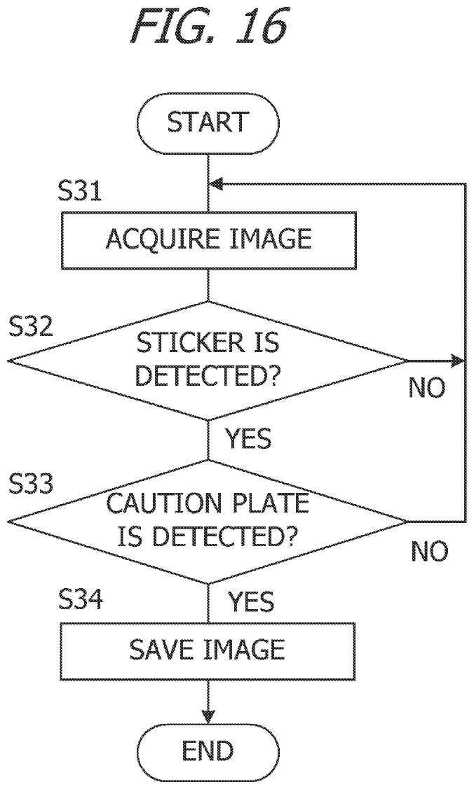

In step S21A, the control unit 101 periodically acquires the image via the camera 105, and detects the two-dimensional code and the chassis number in the image that is acquired. FIG. 16 is a flowchart of processes that are performed by the control unit 101 in step S21A.

First, an image is acquired via the camera 105 in step S31.

Next, in step S32, whether the sticker is detected in an image that is acquired is determined. For example, the sticker may be detected using text or a drawing written on the sticker. Furthermore, that the sticker is detected may be determined in the case where presence of the two-dimensional code is detected in the image. In the case where a positive determination is made in the present step, the process proceeds to step S33. In the case where a negative determination is made in the present step, the process returns to step S31.

In step S33, whether the caution plate is detected in the image that is acquired is determined. For example, the caution plate may be detected using text or a drawing written on the caution plate. In the case where a positive determination is made in the present step, the process proceeds to step S34. In the case where a negative determination is made in the present step, the process returns to step S31.

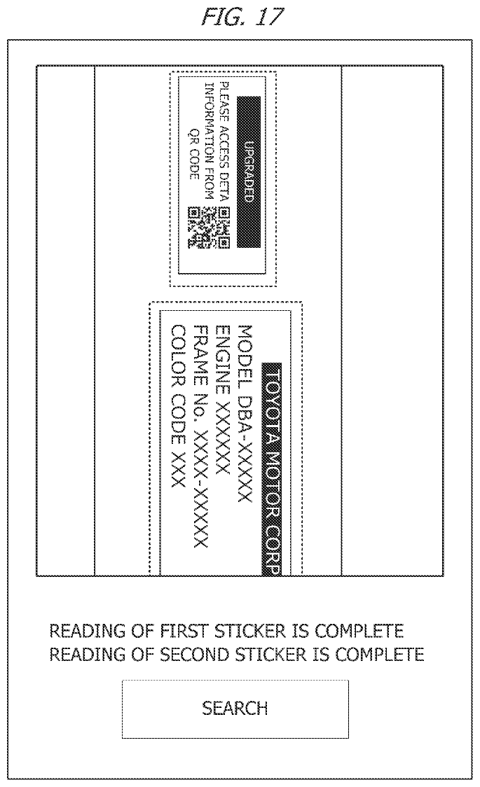

In the case where a positive determination is made in both steps S32 and S33, the image that is acquired is saved in step S34. Additionally, the user may be notified of completion of reading of data at this timing. For example, a notification indicating that the sticker is detected, and that the caution plate is detected may be issued as illustrated in FIG. 17. In the illustrated example, an image captured by the camera 105 is output on the screen in real time, and in the case where the sticker or the caution plate is detected in the image, a message for notification of the same is output. Furthermore, in the case where both the sticker and the caution plate are detected, a button for performing search for the maintenance history is activated.

In the case where the sticker and the caution plate are disposed at separate locations, respective images may be saved at a timing when the sticker is detected and at a timing when the caution plate is detected.

In step S22A, the two-dimensional code included in the sticker is decoded and the URL is acquired by the same process as in step S22.

In step S22B, recognition of the chassis number included in the caution plate is performed. Recognition of the chassis number may be performed by a known character recognition technique. For example, all the characters included in the caution plate may be recognized, and then, a character string following a predetermined character string (such as “FRAME No.”) may be taken as the chassis number.

Subsequently, the user terminal 100 transmits a search request to the URL that is acquired. The vehicle management server 200 generates a response thereto (step S23A). The response that is generated is returned to the user terminal 100.

After receiving the response, the user terminal 100 transmits the chassis number that is recognized in step S22B, to the vehicle management server 200. That is, an operation that is performed by the user in the first embodiment (the step of notifying the vehicle management server 200 of the chassis number) is automatically performed.

The vehicle management server 200 acquires a list of maintenance histories based on the chassis number that is acquired, and generates the user interface screen. This process is the same as that described in relation to step S25, and detailed description thereof is omitted.

As described above, in the second embodiment, the user terminal 100 reads the chassis number using the camera, and transmits the chassis number that is read, to the vehicle management server 200. The user may thus acquire the maintenance history simply by capturing the vehicle body according to an instruction.

(Modifications)

The embodiments described above are merely examples, and the present disclosure may be changed as appropriate within the scope of the disclosure.

For example, the processes and means described in the present disclosure may be freely combined to the extent that no technical conflict exists.

Furthermore, in the description of the embodiments, an example is described where the sticker and the caution plate are attached at adjacent locations, but the two may alternatively be attached at separate locations. For example, the caution plate may be attached inside an engine compartment. In this case, the user terminal 100 may output a notice about the attachment location with respect to each of the sticker and the caution plate, and have the user capture the two.

The attachment location(s) of the sticker and the caution plate may be different depending on the vehicle type. Accordingly, the user terminal 100 (or the vehicle management server 200) may store data about the attachment location(s) of the sticker and the caution plate, and may output a notice matching the target vehicle based on the data. In this case, the user terminal 100 may transmit an identifier for identifying the model of the target vehicle, to the vehicle management server 200, and the vehicle management server 200 may, in response, acquire a notice (a message or an image) matching the model and provide the notice to the user terminal 100.

Furthermore, in the description of the embodiments, the chassis number is used as the identifier of the vehicle, but other texts may also be used as the identifier of the vehicle. For example, a serial number may be printed on the sticker, and the vehicle management server 200 may link the serial number and the chassis number to each other. In this case, the user terminal 100 may transmit the serial number to the vehicle management server 200, instead of the chassis number, and the vehicle management server 200 may identify the chassis number based on the serial number.

Furthermore, in the description of the embodiments, the vehicle management server 200 provides only the history information, but the vehicle management server 200 may also provide other information pieces about upgrade of vehicle parts.

For example, the vehicle management server 200 may acquire, in relation to the target vehicle, a list of vehicle parts that are not yet upgraded, and may generate and provide a list of vehicle parts that can be upgraded. In this case, a list of vehicle parts that can be upgraded may be generated by causing the vehicle management server 200 to store, in relation to each vehicle type, a list of vehicle parts that can be upgraded, and to check the list against the upgrade history of the target vehicle.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical discs (CD-ROMs, DVD discs, Blu-ray discs, etc.), read-only memories (ROMs), random-access memories (RAMs), EPROMs, EEPROMs, magnetic cards, flash memories, optical cards, and any type of medium suitable for storing electronic instructions.

What is claimed is:

1. An information processing apparatus acquiring history information about a vehicle, the information processing apparatus comprising a processor that:
performs reading a code printed on a sticker attached to a vehicle body, and
transmits, to a first apparatus, first data requesting the history information, based on a result of the reading.

2. The information processing apparatus according to claim 1, wherein the code is obtained by encoding a network address for accessing the first apparatus.

3. The information processing apparatus according to claim 2, wherein the processor further acquires an identifier of a target vehicle, and further transmits second data including the identifier to the first apparatus.

4. The information processing apparatus according to claim 3, further comprising a camera, wherein
the processor acquires, via the camera, an image including both the sticker including the code and a plate on which the identifier is written.

5. The information processing apparatus according to claim 4, wherein the processor notifies a user of a location, on the target vehicle, where the sticker and the plate are attached.

6. The information processing apparatus according to claim 5, wherein the processor acquires data in which the target vehicle and the location where the sticker and the plate are attached are associated with each other.

7. The information processing apparatus according to claim 4, wherein the processor performs acquisition of the network address and recognition of the identifier based on the image.

8. The information processing apparatus according to claim 3, wherein the identifier is a chassis number of the target vehicle.

9. The information processing apparatus according to claim 1, wherein the history information includes an upgrade history of components of the vehicle.

10. The information processing apparatus according to claim 9, wherein the sticker displays that any of the components of the vehicle is upgraded.

11. An information processing method performed by an information processing apparatus acquiring history information about a vehicle, the information processing method comprising:
performing reading a code printed on a sticker attached to a vehicle body; and
transmitting, to a first apparatus, first data requesting the history information, based on a result of the reading.

12. The information processing method according to claim 11, wherein the code is obtained by encoding a network address for accessing the first apparatus.

13. The information processing method according to claim 12, further comprising acquiring an identifier of a target vehicle, and transmitting second data including the identifier to the first apparatus.

14. The information processing method according to claim 13, further comprising acquiring, via a camera, an image including both the sticker including the code and a plate on which the identifier is written.

15. The information processing method according to claim 14, further comprising notifying a user of a location, on the target vehicle, where the sticker and the plate are attached.

16. The information processing method according to claim 14, further comprising performing acquisition of the network address and recognition of the identifier based on the image.

17. The information processing method according to claim 13, wherein the identifier is a chassis number of the target vehicle.

18. The information processing method according to claim 11, wherein the history information includes an upgrade history of components of the vehicle.

19. The information processing method according to claim 18, wherein the sticker displays that any of the components of the vehicle is upgraded.

20. A non-transitory computer-readable recording medium stored with a program for causing a computer to perform the information processing method according to claim 11.
